(19) United States
(12) Patent Application Publication
(10) Pub. No.: US 2018/0218507 A1
(43) Pub. Date: Aug. 2, 2018

(54) 3D RECONSTRUCTION OF A HUMAN EAR FROM A POINT CLOUD

(71) Applicant: THOMSON Licensing, Issy-les-Moulineaux (FR)

(72) Inventors: Philipp HYLLUS, Hannover (DE); Bertrand TRINCHERINI, Conthey (CH)

(21) Appl. No.: 15/752,777

(22) PCT Filed: Jan. 27, 2016
(86) PCT No.: PCT/EP2016/051694

§ 371 Date: Feb. 14, 2018

(30) Foreign Application Priority Data
Aug. 14, 2015 (EP) 15306294.8

(51) Int. Cl. G06T 7/33; G06K 9/00

(52) U.S. Cl. CPC G06T 7/344; G06T 2207/30196; G06T 2207/10028; G06K 9/00214

(57) ABSTRACT

A method for 3D reconstruction of an object from a sequence of images, a computer readable medium and an apparatus (20, 30) configured to perform 3D reconstruction of an object from a sequence of images. A point cloud generator (23) generates (10) a point cloud of the object from a sequence of images. An alignment processor (24) coarsely aligns (11) a dummy mesh model of the object with the point cloud. A transformation processor (25) fits (12) the dummy mesh model of the object to the point cloud through an elastic transformation of the coarsely aligned dummy mesh model.

### FIELD

The present solution relates to a method and an apparatus for 3D reconstruction of an object from a sequence of images. Further, the solution relates to a computer readable storage medium having stored therein instructions enabling 3D reconstruction from a set of images. In particular, a solution for 3D reconstruction using dummy-based meshing of a Point Cloud is described.

### BACKGROUND

Generic 3D reconstruction techniques have difficulties reconstructing objects with challenging geometric properties such as crevices, small features, and concave parts which are difficult to capture with a visual system. Therefore, the generated meshes typically suffer from artefacts. Point cloud data is generally more reliable, but there will be holes in the models.

One example of an object with challenging geometric properties is the human ear. FIG. 1 shows an example of human ear reconstruction. An exemplary captured image of the original ear is depicted in FIG. 1a). FIG. 1b) shows a point cloud generated from a sequence of such captured images. A reconstruction obtained by applying a Poisson-Meshing algorithm to the point cloud is shown in FIG. 1c). As can be seen, even though the point cloud captures the details quite well, applying the Poisson-Meshing algorithm leads to artifacts.

One approach to hole filling for incomplete point cloud data is described in [1]. The approach is based on geometric shape primitives, which are fitted using global optimization, taking care of the connections of the primitives. This is mainly applicable to a CAD system.

A method for generating 3D body models from scanned data is described in [2]. A plurality of points clouds obtained from a scanner are aligned and a set of 3D data points obtained by the initial alignment are brought into precise registration with a mean body surface derived from the point clouds. Then an existing mesh-type body model template is fit to the set of 3D data points. The template model can be used to fill in missing detail where the geometry is hard to reconstruct.

### SUMMARY

It is desirable to have an improved solution for 3D reconstruction of an object from a sequence of images.

According to the present principles, a method for 3D reconstruction of an object from a sequence of images comprises:
generating a point cloud of the object from the sequence of images;
coarsely aligning a dummy mesh model of the object with the point cloud; and
fitting the dummy mesh model of the object to the point cloud through an elastic transformation of the coarsely aligned dummy mesh model.

Accordingly, a computer readable non-transitory storage medium has stored therein instructions enabling 3D reconstruction of an object from a sequence of images, wherein the instructions, when executed by a computer, cause the computer to:
generate a point cloud of the object from the sequence of images;
coarsely align a dummy mesh model of the object with the point cloud; and
fit the dummy mesh model of the object to the point cloud through an elastic transformation of the coarsely aligned dummy mesh model.

In one embodiment, an apparatus for 3D reconstruction of an object from a sequence of images comprises:
an input configured to receive a sequence of images;
a point cloud generator configured to generate a point cloud of the object from the sequence of images;
an alignment processor configured to coarsely align a dummy mesh model of the object with the point cloud; and
a transformation processor configured to fit the dummy mesh model of the object to the point cloud through an elastic transformation of the coarsely aligned dummy mesh model.

In another embodiment, an apparatus for 3D reconstruction of an object from a sequence of images comprises a processing device and a memory device having stored therein instructions, which, when executed by the processing device, cause the apparatus to:
receive a sequence of images;
generate a point cloud of the object from the sequence of images;
coarsely align a dummy mesh model of the object with the point cloud; and
fit the dummy mesh model of the object to the point cloud through an elastic transformation of the coarsely aligned dummy mesh model.

According to the present principles, in case it is known that the object belongs to a class of objects sharing some structural properties, a multi-step procedure for 3D reconstruction is performed. First a point cloud is generated, e.g. using a state-of-the-art multi-view stereo algorithm. Then a generic dummy mesh model capturing the known structural properties is selected and coarsely aligned to the point cloud data. Following the coarse alignment the dummy mesh model is fit to the point cloud through an elastic transformation. This combination of up-to-date point cloud generation methods with 3D non-rigid mesh to point cloud fitting techniques leads to an improved precision of the resulting 3D models. At the same time the solution can be implemented fully automatic or in a semi-automatic way with very little user input.

In one embodiment, coarsely aligning the dummy mesh model with the point cloud comprises determining corresponding planes in the dummy mesh model and in the point cloud and aligning the planes of the dummy mesh model with the planes of the point cloud. When the object to be reconstructed has roughly planar parts, then a coarse alignment can be done with limited computational burden by detecting a main plane in the point cloud data and aligning the corresponding main plane of the mesh model with this plane.

In one embodiment, coarsely aligning the dummy mesh model with the point cloud further comprises determining a prominent spot in the point cloud and adapting an orientation of the dummy mesh model relative to the point cloud based on the position of the prominent spot. The prominent spot may be determined automatically of specified by a user input and constitutes an efficient solution for adapting the orientation of the dummy mesh model. One example of a suitable prominent spot is the top point of the ear on the helix, i.e. the outer rim of the ear.

In one embodiment, coarsely aligning the dummy mesh model with the point cloud further comprises determining a characteristic line in the point cloud and adapting at least one of a scale of the dummy mesh model and a position of the dummy mesh model relative to the point cloud based on the characteristic line. For example, the characteristic line in the point cloud is determined by detecting edges in the point cloud. For this purpose a depth map associated with the point cloud may be used. Characteristic lines, e.g. edges, are relatively easy to detect in the point cloud data. As such, they are well suited for adjusting the scale and the position of the dummy mesh model relative to the point cloud data.

In one embodiment, fitting the dummy mesh model of the object to the point cloud through an elastic transformation of the coarsely aligned dummy mesh model comprises determining a border line of the object in the point cloud and attracting vertices of the dummy mesh model that are located outside of the object as defined by the border line towards the border line. Preferably, in order to reduce the computational burden, a 2D projection of the point cloud and the border line is used for determining if a vertex of the dummy mesh model is located outside of the object. A border line is relatively easy to detect in the point cloud data. However, the user may be asked to specify additional constraints, or such additional constraints may be determined using machine-learning techniques and a database.

### BRIEF DESCRIPTION OF THE DRAWINGS

FIG. 1 shows an example of human ear reconstruction;

FIG. 2 is a simplified flow chart illustrating a method for 3D reconstruction from a sequence of images;

FIG. 3 schematically depicts a first embodiment of an apparatus configured to perform 3D reconstruction from a sequence of images;

FIG. 4 schematically shows a second embodiment of an apparatus configured to perform 3D reconstruction from a sequence of images;

FIG. 5 depicts an exemplary sequence of images used for 3D reconstruction;

FIG. 6 shows a representation of a point cloud obtained from a captured image sequence;

FIG. 7 depicts an exemplary dummy mesh model and a cropped point cloud including an ear;

FIG. 8 shows an example of a cropped ear with a marked top point;

FIG. 9 illustrates an estimated head plane and an estimated ear plane for an exemplary cropped point cloud;

FIG. 10 shows an example of points extracted from the point cloud, which belong to the ear;

FIG. 11 illustrates extraction of a helix line from the points of the point cloud belonging to the ear;

FIG. 12 shows an exemplary result of the alignment of the dummy mesh model to the cropped point cloud;

FIG. 13 depicts an example of a selected ear region of a mesh model;

FIG. 14 shows labeling of model ear points as outside or inside of the ear;

FIG. 15 illustrates a stopping criterion for helix line correction;

FIG. 16 shows alignment results before registration; and

FIG. 17 depicts alignment results after registration.

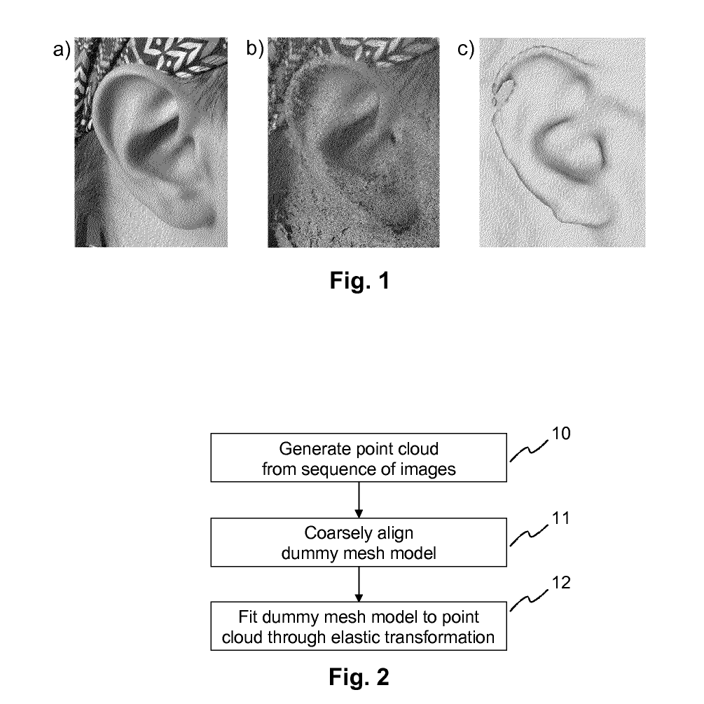

### DETAILED DESCRIPTION OF PREFERRED EMBODIMENTS

For a better understanding the principles of embodiments of the invention shall now be explained in more detail in the following description with reference to the figures. It is understood that the invention is not limited to these exemplary embodiments and that specified features can also expediently be combined and/or modified without departing from the scope of the present invention as defined in the appended claims.

A flow chart illustrating a method for 3D reconstruction from a sequence of images is depicted in FIG. 2. First a point cloud of the object is generated 10 from the sequence of images. A dummy mesh model of the object is then coarsely aligned 11 with the point cloud. Finally, the dummy mesh model of the object is fitted 12 to the point cloud through an elastic transformation of the coarsely aligned dummy mesh model.

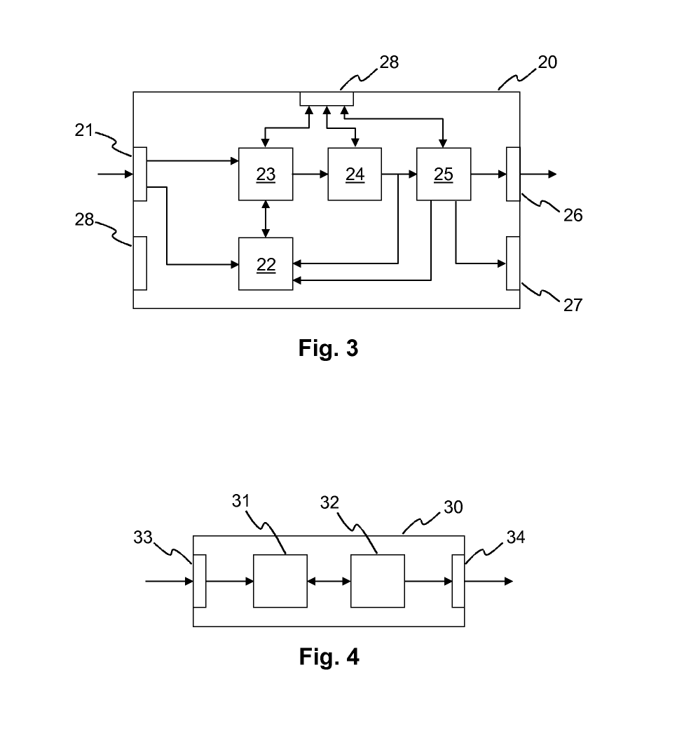

FIG. 3 schematically shows a first embodiment of an apparatus 20 for 3D reconstruction from a sequence of images. The apparatus 20 has an input 21 for receiving a sequence of images, e.g. from a network, a camera, or an external storage. The sequence of images may likewise be retrieved from an internal storage 22 of the apparatus 20. A point cloud generator 23 generates 10 a point cloud of the object from the sequence of images. Alternatively, an already available point cloud of the object is retrieved, e.g. via the input 21 or from the internal storage 22. An alignment processor 24 coarsely aligns 11 a dummy mesh model of the object with the point cloud. A transformation processor 25 fits 12 the dummy mesh model of the object to the point cloud through an elastic transformation of the coarsely aligned dummy mesh model. The final mesh model is then stored on the internal storage 22 or provided via an output 26 to further processing circuitry. It may likewise be processed for output on a display, e.g. a display connected to the apparatus via the output 26 or a display 27 comprised in the apparatus. Preferably, the apparatus 20 further has a user interface 28 for receiving user inputs. Each of the different units 23, 24, 25 can be embodied as a different processor. Of course, the different units 23, 24, 25 may likewise be fully or partially combined into a single unit or implemented as software running on a processor. Furthermore, the input 21 and the output 26 may likewise be combined into a single bidirectional interface.

A second embodiment of an apparatus 30 for 3D reconstruction from a sequence of images is illustrated in FIG. 3. The apparatus 30 comprises a processing device 31 and a memory device 32 storing instructions that, when executed, cause the apparatus to receive a sequence of images, to generate 10 a point cloud of the object from the sequence of images, coarsely align 11 a dummy mesh model of the object with the point cloud, and to fit 12 the dummy mesh model of the object to the point cloud through an elastic transformation of the coarsely aligned dummy mesh model. The apparatus 30 further comprises an input 33, e.g. for receiving instructions, user inputs, or data to be processed, and an output 34, e.g. for providing processing results to a display, to a network, or to an external storage. The input 33 and the output 34 may likewise be combined into a single bidirectional interface.

For example, the processing device 31 can be a processor adapted to perform the above stated steps. In an embodiment said adaptation comprises a processor configured to perform these steps.

A processor as used herein may include one or more processing units, such as microprocessors, digital signal processors, or combination thereof.

The memory device 32 may include volatile and/or non-volatile memory regions and storage devices such as hard disk drives, DVD drives. A part of the memory is a non-transitory program storage device readable by the processing device 31, tangibly embodying a program of instructions executable by the processing device 31 to perform program steps as described herein according to the principles of the invention.

In the following the solution according to the present principles shall be explained in greater detail at the example of 3D reconstruction of a human ear. Reliable ear models are particularly interesting for high quality audio systems, which create the illusion of spatial sound sources in order to enhance the immersion of the user. One approach to create the illusion of spatial audio sources is the binaural audio. The term “binaural” is typically used for systems that attempt to deliver independent signal to each ear. The purpose is to create two signals as close as possible to the sound produced by a sound source object. The bottleneck of creating such systems is that every human has his own ear's/head's/shoulder's shape. As a consequence the head related transfer function (HRTF) is different for each human. The HRTF is a response that characterizes how an ear receives a sound from a point in space and which frequencies are attenuated or not. Generally, a sound source is not perceived in the same way by different individuals. A non-individualized HRTF binaural system therefore tends to increase the confusion between different sound source localizations. For such systems, the HRTF has to be computed individually before creating a personalized binaural system. In HRTF computation, the ear shape is the most important part of the human body and the 3D model of the ear should be of better quality than the one for the head and the shoulder.

Unfortunately, an ear is very difficult to reconstruct due to its challenging geometry. The detailed structure is believed to be unique to an individual, but the general structure of the ear is the same for any human. Therefore, it is a good candidate for the 3D reconstruction according to the present principles.

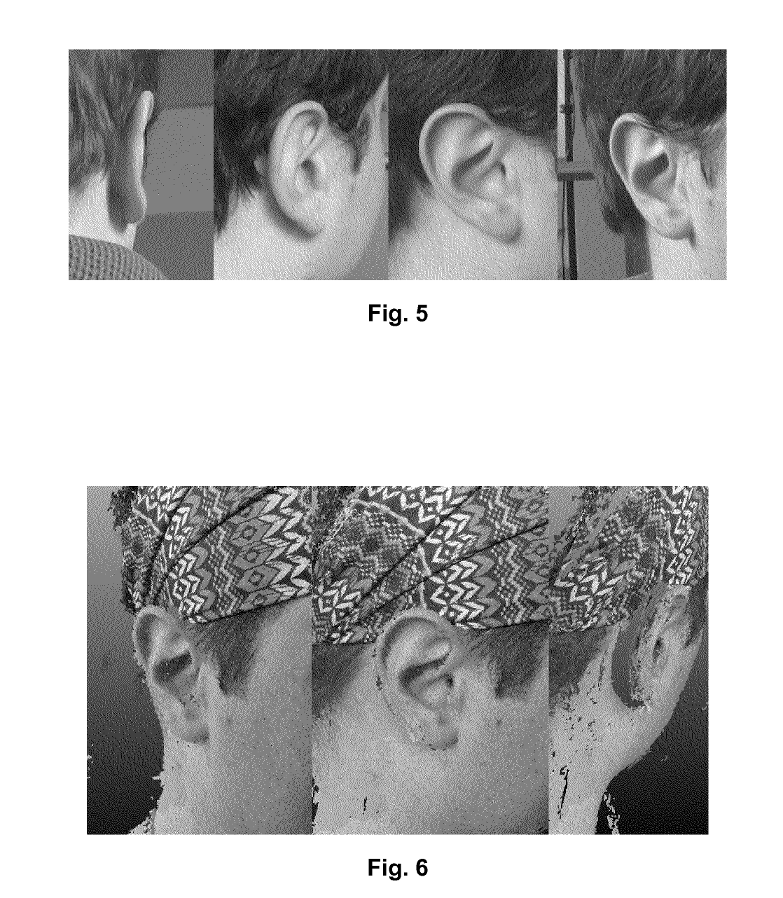

The reconstruction assumes that a sequence of images of the ear is already available. An exemplary sequence of images used for 3D reconstruction is depicted in FIG. 5. Also available are camera positions and orientations. For example, the camera positions and orientations may be estimated using a multi view stereo (MVS) method, e.g. one of the methods described in [3]. From these data a 3D point cloud is determined, using, for example, the tools PhotoScan by Agisoft [4] or 123DCatch by Autodesk [5]. FIG. 6 gives a representation of the point cloud obtained with the PhotoScan tool for a camera setup where all cameras are put on the same line and very close to each other.

There are some holes in the model, especially in occluded areas (behind the ear and inside), but in general a good model is achieved.

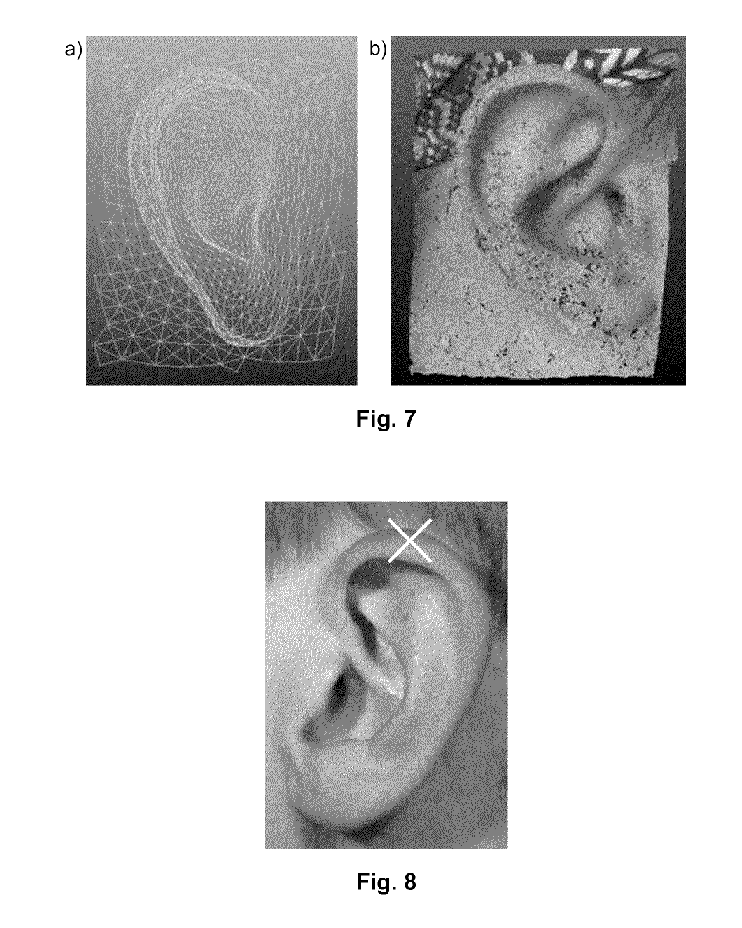

According to the present principles, the reconstruction starts with a rough alignment of a dummy mesh model to the point cloud data. In order to simplify integration of the ear model into a head model at a later stage, the dummy mesh model is prepared such that it includes part of the head as well. The mesh part of the head is cropped such that it comprises a rough ear plane, which can be matched with an ear plane of the point cloud. An exemplary dummy mesh model and a cropped point cloud including an ear are illustrated in FIG. 7a) and FIG. 7b), respectively.

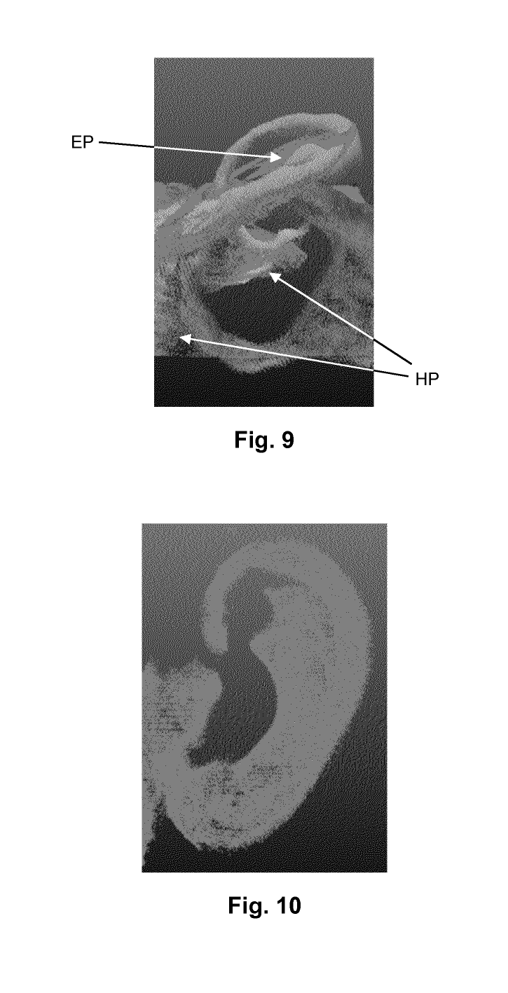

The rough alignment of the dummy mesh model is split into two stages. First the model is aligned to the data in 3D. Then orientation and scale of the model ear are adapted to roughly match the data. The first stage preferably starts with extracting a bounding box for the ear. This can be done automatically using ear detection techniques, e.g. one of the approaches described in [6]. Alternatively, the ear bounding box extraction is achieved by simple user interaction. From one of the images used for reconstructing the ear, which contains a lateral view of the human head, the user selects a rectangle around the ear. Advantageously, the user also marks the top point of the ear on the helix. These simple interactions avoid having to apply involved ear detection techniques. An example of a cropped ear with a marked top point is depicted in FIG. 8. From the cropping region a bounding box around the ear is extracted from the point cloud. From this cropped point cloud two planes are estimated, one plane HP for the head points and one plane EP for the points on the ear. For this purpose a modified version of the RANSAC plane fit algorithm described in [1] is used. The adaptation is beneficial because the original approach assumes that all points are on a plane, while in the present case the shapes deviate substantially in the orthogonal direction. FIG. 9 shows the two estimated planes HP, EP for an exemplary cropped point cloud.

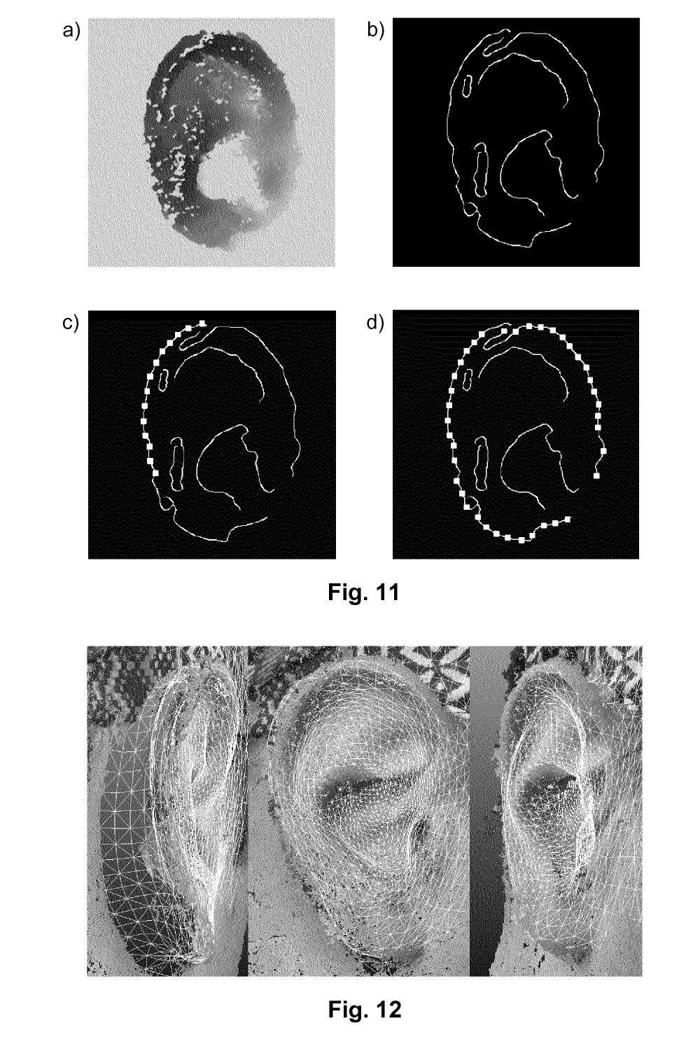

The ear plane is mainly used to compute the transformation necessary to align the ear plane of the mesh model with that of the point cloud. The fit enables a simple detection of whether the point cloud shows the left ear or the right ear based on the ear orientation (obtained, for example, from the user input) and the relative orientation of the ear plane and the head plane. In addition, the fit further allows extracting those points of the point cloud that are close to the ear plane. One example of points extracted from the point cloud, which belong to the ear, is shown in FIG. 10. From these points the outer helix line can be extracted, which simplifies estimating the proper scale and the ear-center of the model. To this end, from the extracted points of the point cloud a depth map of the ear points is obtained. This depth map generally is quite good, but it may nonetheless contain a number of pixels without depth information. In order to reduce this number, the depth map is preferably filtered. For example, for each pixel without depth information the median value from the surrounding pixels may be computed, provided there are sufficient surrounding pixels with depth information. This median value will then be used as the depth value for the respective pixel. A useful property of this median filter is that it does not smooth the edges from the depth map, which is the information of interest. An example of a filtered depth map is shown in FIG. 11a). Subsequently, as illustrated in FIG. 11b), edges are extracted from the filtered depth map. This may be done using a canny edge detector. From the detected edges connected lines are extracted. In order to finally extract the outer helix, the longest connected line on the right/left side for a left/right ear is taken as a starting line. This line is then down-sampled and only the longest part is taken. The longest part is determined by following the line as long as the angle between two consecutive edges, which are defined by three consecutive points, does not exceed a threshold. An example is given in FIG. 11c), where the grey squares indicate the selected line. The optimum down-sampling factor is found by maximizing the length of the helix line. As a starting point, a small down-sampling factor is chosen and is then iteratively increased. Only the factor that gives the longest outer helix is kept. This technique allows “smoothing” the line, which could be corrupted by some outliers. It is further assumed that the helix is smooth and does not contain abrupt changes of the orientation of successive edges, which is enforced by the angle threshold. Depending on the quality of the data, the helix line can be broken. As a result, the first selected line may not span the entire helix bound. By looking for connections between lines with a sufficiently small relative skew and which are sufficiently close, several lines may be connected, as depicted in FIG. 11d).

With the information obtained so far the rough alignment can be computed. To this end the model ear plane is aligned to the ear plane in the point cloud. Then the orientation of the model ear is aligned with that of the point cloud ear by a rotation in the ear plane. For this purpose the user selected top position of the ear is preferably used. In a next step the size and the center of the ear are estimated. Finally, the model is translated and scaled accordingly. An exemplary result of the adaptation of the mesh ear model to the cropped point cloud is shown in FIG. 12.

Following the rough alignment a finer elastic transformation is applied in order to fit the mesh model to the data points. This is a specific instance of a non-rigid registration technique [7]. Since the ear is roughly planar and hence can be characterized well by its 2D structure, the elastic transformation is performed in two steps. First the ear is aligned according to 2D information, such as the helix line detected before. Then a guided 3D transformation is applied, which respects the 2D conditions. The two steps will be explained in more detail in the following.

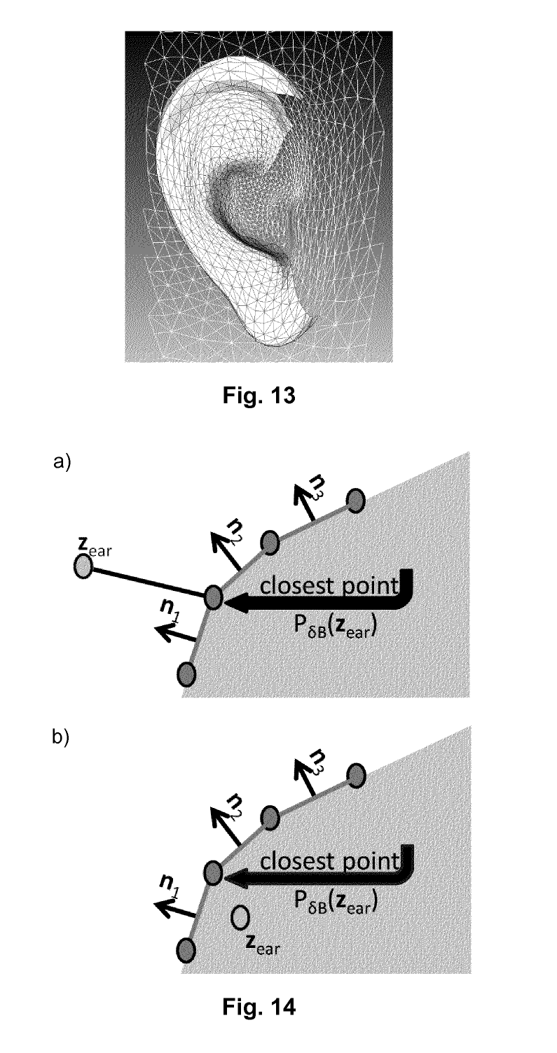

For model preparation an ear region of the mesh model is selected, e.g. by a user input. This selection allows classifying all mesh model vertices as belonging to the ear or to the head. An example of a selected ear region of a mesh model is shown in FIG. 13, where the ear region is indicated by the non-transparent mesh.

In the following the non-rigid alignment of the mesh model shall be explained with reference to FIG. 14. For the non-rigid alignment the mesh model can be deformed to match the data points by minimizing a morphing energy consisting of:
a point-to-point energy for a model vertex and its closest data-point;
a point-to-plane energy for a model vertex, its closest data-point, and the normal of it;
a global rigid transformation term; and
a local rigid transformation term.

This allows an elastic transformation. However, this energy is adapted for the present solution, as will be described below. Note that only the 2D locations of all the points in the ear plane are considered.

In order to make use of the helix line, the extracted helix boundary is first up-sampled. For each model ear point zₑₐᵣ it is then decided whether it is inside (nᵢ·(zₑₐᵣ−P_{δB}(zₑₐᵣ))>0) or outside (nᵢ·(zₑₐᵣ−P_{δB}(zₑₐᵣ))<0) the projection of the ear in the 2D plane, where nᵢ are the normals of the helix line element adjacent to the closest helix data point.

Outside points are attracted towards the closest point on the boundary by adding an extra energy to the morphing energy. The model points are not allowed to move orthogonally to the ear plane. This is shown in FIG. 14, where FIG. 14a) depicts a case where the model ear point zₑₐᵣ is labeled “outside”, whereas FIG. 14b) depicts a case where the model ear point zₑₐᵣ is labeled “inside”.

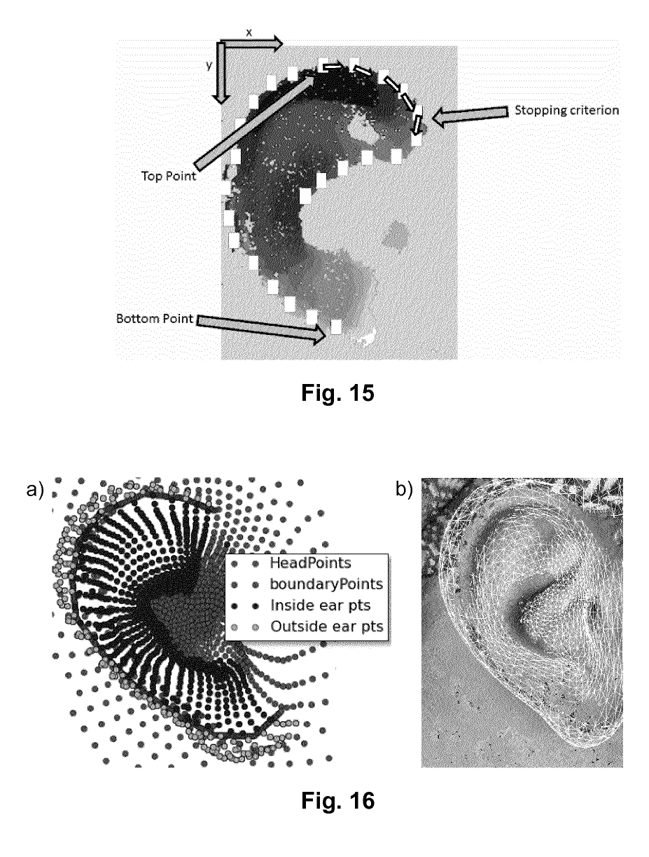

It may happen that the extracted helix continues inside of the ear on the top and on the bottom. This leads to bad alignment of the model to the data. To prevent this, the decision process starts from the previously identified top ear point. When moving along the line the x-deviation of a 2D point relative to the previous one is checked. The helix is cut where this deviation turns negative, signaling that the helix line turns inwards. This works in an analogous manner for the bottom point. This stopping criterion is illustrated in FIG. 15.

The user may be asked to identify further 2D landmarks as constraints in addition to the available helix line. In any case, after the alignment in 2D, a full 3D elastic transformation is performed. However, alignment with the 2D lines and landmarks is kept as follows. For the 2D line constraint a subset of the “outside” ear model vertices is selected after the 2D alignment, which are then used as 2D landmarks. For each landmark, a 3D morphing energy attracting the model landmark vertex to the landmark position in 2D is added. This keeps the projection of the landmark vertices on the ear plane in place

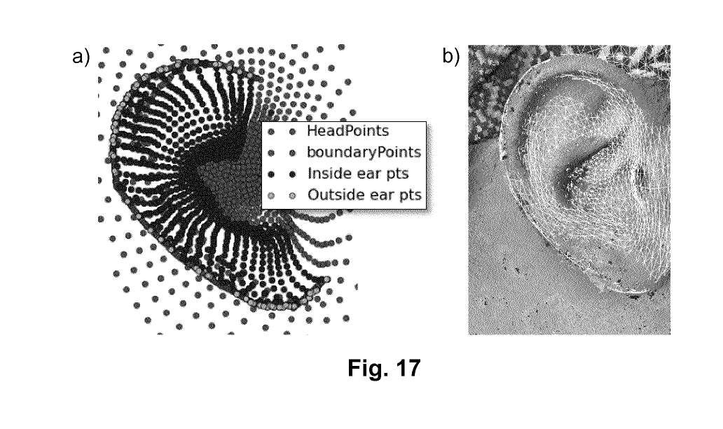

Exemplary alignment results are shown in FIG. 16 and FIG. 17, where FIG. 16 depicts results before registration and FIG. 17 results after registration. In both figures the left part shows the model ear points and the projected helix line, whereas the right part depicts the mesh ear model superimposed on the point cloud. From FIG. 17 the improved alignment of the mesh ear model to the cropped point cloud is readily apparent. The outside points are well aligned with the projected helix line in 2D after the energy minimization. The mesh has been transformed elastically in the ear region without affecting the head region.

### CITATIONS

[1] Schnabel et al.: “Efficient RANSAC for point-cloud shape detection”, Computer graphics forum, Vol. 26 (2007), pp. 214-226.
[2] GB 2 389 500 A.
[3] Seitz et al.: “A Comparison and Evaluation of Multi-View Stereo Reconstruction Algorithms”, 2006 IEEE Computer Society Conference on Computer Vision and Pattern Recognition (CVPR), pp. 519-528.
[4] PhotoScan Software: www.agisoft.com/
[5] 123DCatch Software: www.123dapp.com/catch.
[6] Abaza et al.: “A survey on ear biometrics”, ACM computing surveys (2013), Vol. 45, Article 22.
[7] Bouaziz et al.: “Dynamic 2D/3D Registration”, Eurographics (Tutorials) 2014.

1. A method for 3D reconstruction of an object from a sequence of images, the method comprising:
generating a point cloud of the object from the sequence of images;
aligning a dummy mesh model of the object with the point cloud; and
fitting the dummy mesh model of the object to the point cloud through an elastic transformation of the aligned dummy mesh model.

2. The method according to claim 1, wherein aligning the dummy mesh model with the point cloud comprises determining corresponding planes in the dummy mesh model and in the point cloud and aligning the planes of the dummy mesh model with the planes of the point cloud.

3. (canceled)

4. The method according to claim 2, wherein aligning the dummy mesh model with the point cloud further comprises determining a characteristic line in the point cloud and adapting at least one of a scale of the dummy mesh model and a position of the dummy mesh model relative to the point cloud based on the characteristic line.

5. The method according to claim 4, wherein determining the characteristic line in the point cloud comprises detecting edges in the point cloud.

6. The method according to claim 4, wherein detecting edges in the point cloud uses a depth map associated with the point cloud.

7. The method according to claim 1, wherein fitting the dummy mesh model of the object to the point cloud through an elastic transformation of the aligned dummy mesh model comprises:
determining a border line of the object in the point cloud; and
attracting vertices of the dummy mesh model that are located outside of the object as defined by the border line towards the border line.

8. The method according to claim 7, wherein a 2D projection of the point cloud and the border line is used for determining if a vertex of the dummy mesh model is located outside of the object.

9. A non-transitory computer readable storage medium having stored therein instructions enabling 3D reconstruction of an object from a sequence of images, wherein the instructions, when executed by a computer, cause the computer to:
generate a point cloud of the object from the sequence of images;
align a dummy mesh model of the object with the point cloud; and
fit the dummy mesh model of the object to the point cloud through an elastic transformation of the aligned dummy mesh model.

10. An apparatus for 3D reconstruction of an object from a sequence of images, the apparatus comprising:
an input configured to receive a sequence of images;
a point cloud generator configured to generate a point cloud of the object from the sequence of images;
an alignment processor configured to align a dummy mesh model of the object with the point cloud; and
a transformation processor configured to fit the dummy mesh model of the object to the point cloud through an elastic transformation of the aligned dummy mesh model.

11. An apparatus for 3D reconstruction of an object from a sequence of images, the apparatus comprising a processing device and a memory device having stored therein instructions, which, when executed by the processing device, cause the apparatus to:
receive a sequence of images;
generate a point cloud of the object from the sequence of images;
align a dummy mesh model of the object with the point cloud; and
fit the dummy mesh model of the object to the point cloud through an elastic transformation of the aligned dummy mesh model.
